(19) United States
(12) Patent Application Publication
(10) Pub. No.: US 2005/0057336 A1
(43) Pub. Date: Mar. 17, 2005

(54) Thermal protector and a method for reducing a contact resistance of same

(76) Inventors: Koichi Toyosaki, Tokyo (JP); Kiyoshi Yamamoto, Tokyo (JP); Akira Morii, Tokyo (JP); Takeshi Nagai, Tochigi (JP)

Correspondence Address: CANTOR COLBURN LLP, 55 Griffin Road South, Bloomfield, CT, 06002, US

(21) Appl. No.: 10/942,414

(22) Filed: Sep. 16, 2004

(30) Foreign Application Priority Data
Sep. 16, 2003 (JP) 2003-322616
Jul. 15, 2004 (JP) 2004-208938

(51) Int. Cl. H01H 61/04; H01H 61/01

(52) U.S. Cl. 337/85

(57) ABSTRACT

A method for forming an activated trace on both of a first and second contact point surface or either a first or second contact point surface by applying vibration while applying an electric current, wherein a first contact point electrically is connected to a first external terminal and a second contact point electrically connected to a second external terminal being aligned opposed to said a first contact point in pair. And an electrical components such as a thermal protector, a cellular phone and a notebook personal computer in the like which adopted the process.

### FIELD OF THE INVENTION

The invention relates to a thermal protector that preventively protects motors or equipments from damage or failure caused by excess-electrical current or over-heating by cutting off the current. In particular, an electrical components having a small contact devices such as a thermal protector, a relay switch or a reed switch used in a rechargeable battery for a cellular phone and a notebook personal computer, and used in a small motor, an automotive use motor, a direct-current circuits of a charger and an alternative-current circuits for a fan motor of air-conditioner or a general use motor for washing machine or the like, and a small electrical apparatus adopted those electrical components.

### RELATED ART

A small space factor and higher performance are getting remarkably important consideration in recent electric equipments such as a cellular phone and a notebook computer, also a thermal protector used in those applications is required smaller physical dimension with higher performance accordingly.

A conventional type thermal protector as illustrated in FIG. 5 is used as assembled in a small battery pack for a cellular phone, constructed from a fixed plate 6 having a fixed contact point 4a on one end and a first external terminal 5a for connecting to external circuitry, and a movable plate 7b, both enclosed in a space surrounded by a housing 1 which is formed by a thin metal plate having a concave-shaped part 1a in the upper side thereof, and a supporting member 2 which is formed by a non electrical conductive resin material. The movable plate 7b is made by an elastic metal material and comprising a movable contact point 4b aligned opposed to the fixed contact point 4a on one side, and a second external terminal 5b for connecting to external circuitry on other side. A thermo-sensitive movable element 8 made of bimetal that is in a convex shape at normal temperature is mounted above the movable plate 7b and functions to force the movable plate 7b up and down wards.

The movable contact point 4b of the thermal protector is maintained to contact to the fixed contact point 4a at normal temperature by a pressure of an elastic force of the movable plate 7b while a thermo-sensitive bimetal 8 is in contact to the concave 1a.

When ambient temperature rises to predetermined temperature, a convex-shaped thermo-sensitive movable element projecting to upper direction starts to change to a concave shape. It pulls the movable piece 7b upwards and the pressure applied to a movable contact point 4b is released then makes to separate from the fixed contact point 4a, and cut off electric current flow. By adopting the thermal protector, it can protects a mobile type electronic equipment such as a cellular phone and a notebook computer from a damage caused by over heating or over current of a small battery pack. (Reference: Japanese Patent Provisional Publication No. 2001-307607).

It is possible to miniaturize according to the construction of a conventional type thermal protector with a smaller size thermo-sensitive movable element. However, its reverse force is getting weaker as its size of thermo-sensitive movable element is smaller. Accordingly, a pressure receiving from a movable plate to a contact point decreases. Furthermore it may increase its contact resistance when a contact position changes which caused by a dropping, vibration or deforming. Therefore, a problem of increasing of contact resistance between a movable contact point and a fixed contact point may arise due to this reason. The increasing of contact resistance will cause a loss of electric current energy due to heat dissipation and cause a melting down of contact point, then making insulation parts which will cease a current flow, hence an apparatus may become out of work situation. Particularly, the problem of shifting contact point caused by a dropping of a portable equipment such as a cellular phone and a notebook personal computer will call a customer claim.

It is known that mechanism of the increasing of contact resistance is; 1st) a pressure given by a movable plate is so small as not to break an oxidation layer of a contact point, 2nd) a fretting phenomenon which is caused by gathering of an oxidation material during vibration-bonding process of resin cases when assembling a thermal protector.

Conventionally, in order to solve the problem and reduce its contact resistance, an oxidation material on a surface of contact point is removed and new surface is exposed by a spark induced when a contact point is about to open by a reversal movement of a thermo-sensitive movable element driven by so large electric current flows to an external terminals as a thermo-sensitive movable element responds. The above-mentioned activation treatment was implemented by only applying the electrical current. However, the conventional method has a problem with a large variation in terms of spark condition by applying electrical current, and in case of a small thermal protector used for a cellular phone, even though very rare chance, its contact resistance increases due to shifting of a contact point when it falls down. Therefore a new activating method has been expected to develop. Furthermore, in other applications, after long usage, there is a problem with increasing of contact resistance due to shifting of contact position caused by various reason such as releasing a residue stress of a movable plate, a deforming and vibration induced from a installed machine etc. Therefore, it has been needed to solve these problems.

Considering the above-mentioned problems, the present invention is providing a thermal protector with a feature of avoiding an increasing of contact resistance caused by an insufficient contact pressure or by shifting of contacts position induced by a falling, vibration, a deforming or the like, and in addition, a method for reducing a contact resistance of contacts.

### SUMMARY OF THE INVENTION

Activation treatment in the contact point of the switches in such as the thermal protector of the invention is featured so as to be implemented by applying vibration and electric current flow to the contact point. Furthermore, the present invention has a feature in a manner to form the activated trace as well as the area of the activated trace, when the treatment process, conditions and the method of the present invention is applied thereto. The present invention is therefore applicable to the thermal protector with activated trace, electrical components in relation to switches, and small sized electrical appliances including the electrical components. Here, the activation treatment in the present invention means a method for forming an activated trace by applying both of the vibration and the electric current flow whereas the activated trace in the conventional method relates to the activated trace formed by applying only the electrical current flow. The summary of the invention is described hereunder.

The first embodiment of a thermal protector of the invention is a thermal protector which functions to close or open contact between a first contact point and a second contact point being aligned opposed to the first contact point provided on a movable plate, wherein said thermal protector has an activated trace formed by applying vibration and electrical current flow during an activation process on at least one surface of said first contact point and said second contact point.

The second embodiment of a thermal protector of the invention is a thermal protector comprising:

a first contact point electrically connected to a first external terminal through a fixed plate; and,

a second contact point being aligned opposed to said first contact point and electrically connected to a second external terminal through a movable plate,

wherein said thermal protector has an activated trace formed by applying vibration and electrical current flow during an activation process on at least one surface of said first contact point and said second contact point.

The third embodiment of a thermal protector of the invention is a thermal protector comprising:

a first contact point electrically connected to a first external terminal through a fixed plate;

a second contact point which being aligned opposed to said first contact point and electrically connected to a second external terminal through a movable plate; and,

a device to force to separate a contact between said first contact point and said second contact point,

wherein said thermal protector has an activated trace formed by applying vibration and electrical current flow during an activation process on at least one surface of said first contact point and said second contact point.

The fourth embodiment of a thermal protector of the invention is a thermal protector comprising:

a first contact point electrically connected to a first external terminal through a fixed plate; and,

a second contact point electrically connected to a second external terminal through a movable plate,

wherein an activated trace is formed on a surface of said first contact point, and said activated trace comprises a collectives of activated trace gathering from a piece of trace which is partially overlapped.

The fifth embodiment of a thermal protector of the invention is a thermal protector comprising:

a first contact point electrically connected to a first external terminal through a fixed plate;

a second contact point electrically connected to a second external terminal through a movable plate; and,

a device to force to separate a contact between said first contact point and said second contact point,

wherein an activated trace is formed on a surface of said first contact point, and said activated trace comprises a collectives of activated trace gathering from a piece of trace which is partially overlapped.

The sixth embodiment of a thermal protector of the invention is a thermal protector, wherein an activated trace formed on said first contact point processed with applying vibration has a larger area than that processed without vibration when same electric current value is used to form activated trace.

The seventh embodiment of a thermal protector of the invention is a thermal protector, wherein an activated trace formed on said first contact point processed with applying vibration has a larger area by at least two times than an average area formed on said first contact point processed without vibration.

The eighth embodiment of a thermal protector of the invention is a thermal protector, wherein an activated trace formed on said first contact point processed with applying vibration has a larger area by at least four times than an average area formed on said first contact point processed without vibration.

The ninth embodiment of a thermal protector of the invention is a thermal protector, wherein a movable plate is formed by a thermal sensitive element.

The tenth embodiment of a thermal protector of the invention is a thermal protector, wherein a thermo-sensitive movable element functions to separate contact of said first contact point and said second contact point being aligned opposed in pair.

The eleventh embodiment of a thermal protector of the invention is a thermal protector, wherein said first contact point and second contact point are made of one metal selected from a group consisting of Ag, Ni, Cu, Be, Ti, Fe. Cr and C, or an alloy thereof.

The first embodiment of a method for reducing a contact resistance of the invention is a method for reducing contact resistance of electrical contact points in an electrical apparatus including a first external terminal and second external terminal which are electrically isolated, a first contact point electrically connected to said first external terminal, and a second contact point electrically connected to said second external terminal being aligned opposed to the first contact point in pair, comprising the steps of:

maintaining surfaces of said first contact point and said second contact point to be closed state; and,

forming an activated trace with applying vibration and electrical current flow to form a activated trace.

The second embodiment of a method for reducing a contact resistance of the invention is a method for reducing contact resistance of electrical contact points in an electrical apparatus including a first external terminal and a second external terminal which are electrically isolated, a first contact point electrically connected to said first external terminal, a second contact point electrically connected to said second external terminal being aligned opposed to the first contact point in pair, and a device to force to separate a contact between said first contact point and said second contact point, comprising the steps of:

maintaining surfaces of said first contact point and said second contact point to be closed state; and,

forming an activated trace with applying vibration and electrical current flow to form a activated trace.

The third embodiment of a method for reducing a contact resistance of the invention is a method for reducing contact resistance of electrical contact point, wherein said electrical contact point comprises a contact points in a thermal protector.

The fourth embodiment of a method for reducing a contact resistance of the invention is a method for reducing contact resistance of a thermal protector, wherein vibration in a range of 1 kHz-1 GHz frequency and 0.001-0.5 mm amplitude is applied for duration of 0.001-1 second, while applying an electric current flow of 0.1-50 ampere to said first and second contact point while in closed state.

The fifth embodiment of a method for reducing a contact resistance of the invention is a method for reducing contact resistance of a thermal protector, wherein vibration in a range of 10 kHz-100 KHz frequency and 0.01-0.1 mm amplitude is applied for duration of 0.01-0.1 second, while applying an electric current flow of 1-30 ampere.

The sixth embodiment of a method for reducing a contact resistance of the invention is a method for reducing contact resistance of a thermal protector, wherein vibration to activate is applied in simultaneous when welding a housing of a thermal protector to utilize vibration induced from welding, continuous from welding process of a housing, or later following after welding process of a housing.

One embodiment of electrical components of the invention is an electrical component having said thermal protector.

One embodiment of a cellular phone of the invention is a cellular phone having said thermal protector.

One embodiment of a notebook personal computer of the invention is a notebook personal computer having said thermal protector.

The one embodiment of a mobile type electrical apparatus notebook personal computer of the invention is a mobile type electrical apparatus having said thermal protector.

### BRIEF DESCRIPTION OF DRAWINGS

FIG. 1 is a cross-sectional view of a thermal protector having a movable plate integrated;

FIG. 2 is a cross-sectional view of a thermal protector comprising an external terminal and a movable plate separately;

FIG. 3 shows a configuration of vibration and electric current applied to a thermal protector;

FIG. 4-A is an optical microscopic photograph showing an activated trace of a first contact point formed by a conventional method;

FIG. 4-B is an optical microscopic photograph showing an activated trace of a first contact point formed by a method of the present invention; and

FIG. 5 is a cross-sectional view of conventional thermal protector.

### DETAILED DESCRIPTION OF THE PREFERRED EMBODIMENTS

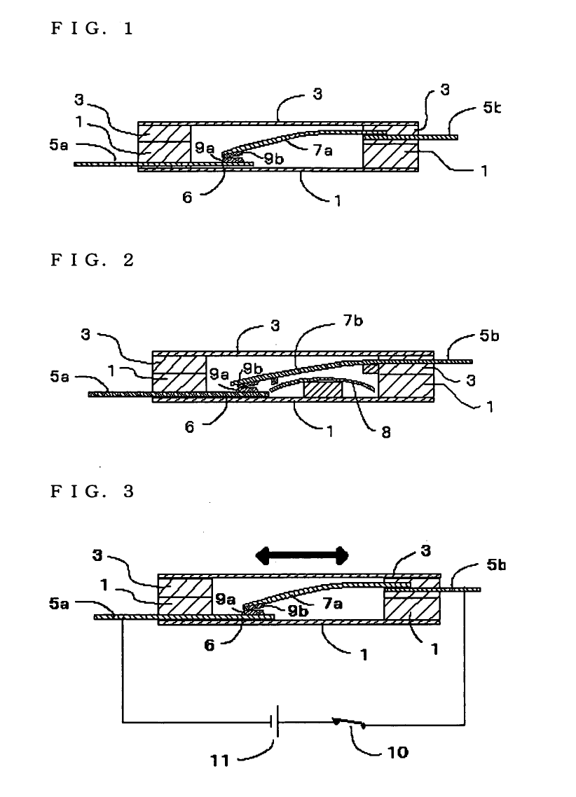

Each of FIG. 1 and FIG. 2 shows a cross-sectional view of a thermal protector in use which embodied in accordance with the present invention. FIG. 3 is describing a configuration how vibration and electric current is applied to the thermal protector in accordance with the invention.

FIG. 1 shows one example of the thermal protector which embodied in accordance with the invention. The thermal protector in accordance with the invention includes a first external terminal 5a for connecting to an external circuit, a second external terminal 5b, a fixed plate 6, and a movable plate 7a made by a thermo-sensitive movable element, which are enclosed in a space surrounded by a housing 1 and top enclosure 3 made by an electric insulating resin material.

The fixed plate 6 includes the first external terminal 5a on one end and a first contact point 9a on other end which is typically a fixed contact and having an activated trace according to the invention. The movable plate 7a, functioning also as a thermo-sensitive movable element, includes a second contact point 9b on one end which is a movable contact point and aligned opposed to the first contact point 9a and the other end is electrical connected to the second external terminal 5b. The activated trace according to the invention is recognized being generated on the surface of the second contact point 9b. A contact between the first contact point 9b and the second contact point 9b is maintained as closed by elastic force of the movable plate 7a when a normal current flows through to it, but it is brought to open and cut off the current flow by a reversal action when an irregular current flows to the contact points, or when a temperature inside a housing arises and reaches to predetermined operating temperature of the movable plate 7a.

The thermal protector in accordance with the invention is constructed by an integration of the fixed plate 6, having the first contact point 9a and the first external terminal 5a, into an inner bottom of an insulating resin housing 1 by a method of insetting molding. Then, the movable plate 7a, having the second contact point 9b and the second external terminal 5b, is integrated into an insulating resin top enclosure 3 by a method of insetting molding.

The housing 1 and the top enclosure 3 are assembled together and bonded by a method of ultrasonic bonding.

FIG. 2 shows another example of a thermal protector which embodied in accordance with the invention. The thermal protector in accordance with the invention includes a first external terminal 5a for connecting to external circuit, a second external terminal 5b, a fixed plate 6, a movable plate 7b, and a thermo-sensitive movable element 8 which are enclosed in a space surrounded by the housing 1 and the top enclosure 3 made of an electric insulating resin material.

The fixed plate 6 includes the first external terminal 5a on one end and a first contact point 9a having an activated trace in accordance with the invention on the surface of the other end. The movable plate 7b is made of an elastic metal material, and includes a second contact point 9b on one end being aligned opposed to the first contact point, which also has an activated trace in accordance with the invention on the surface thereof. The second external terminal 5b for connecting to an external circuit is provided on the other end thereof.

The thermo-sensitive movable element 8 which forces to move the movable plate 7b upward and downwards is mounted in a convex shape under the movable plate 7b. The first contact point 9a and the second contact point 9b are maintained as closed by elastic force of the movable plate 7b. A current flow ceases when the contact is forced to be open by a reversing action of thermo-sensitive movable element 8.

A thermal protector in accordance with the invention is constructed by an integration of a fixed plate 6, having a first contact point 9a and a first external terminal 5a, into an inner bottom of an insulating resin housing 1 by a method of insetting molding. Then, a movable plate 7a, having a second contact point 9b and a second external terminal 5b, is integrated into an insulating resin top enclosure 3 by a method of insetting molding. The housing 1 and the top enclosure 3 are assembled together and bonded by a method of ultrasonic bonding after placing a thermo-sensitive movable element 8 into the housing 1.

After assembling a thermal protector, an activated trace is formed on a surface of the contact point by applying an electric current during vibration in accordance with the invention. A method of activation according to the invention is to form on the first contact point a large collectives of activated traces growing from a multiple activated traces which is exposing new area and changing its position by a movement induced by vibration of the second contact point 9b. Because the activated traces being formed on the first contact point 9a adopts the method of activation process which is applying an electrical current while giving vibration according to the invention, it becomes a collectives having continuous contour formed from newly exposed surface area, the new surface area of which is moving and gradually exposed on the surface of the first contact point 9a, which is induced by vibration of a second contact point 9b. As a result, the area of activated traces becomes larger dimension, hence the contact resistance of the contact points decreases effectively. Wherein, a newly exposed area of the second contact point 9b increases due to a change of a contact angle to the first contact point during a movement of the movable plate 7b, or worn-out of the contact surface during activation. But it is not to say that the activated area of the first contact point, which is caused by movement of the second contact point, is larger than that of the second contact point.

For the first contact point 9a and the second contact point 9b, any one material of Ag, Ni, Cu, Be, Ti, Fe, Cr, or C, or an alloy thereof may be used. Ag—Ni alloy, in particular Ag-10 mass % Ni alloy has a remarkable effect. In addition, Au—Cu alloy, Au—Ag alloy, Ag—C alloy, or W—Ag alloy may be used as well. For a method for joining a fixed plate 6 and a movable plate 7a, 7b to the contact point, typically a cladding, plating, or crimping is applicable but not imitated thereto. For example, a phosphor-bronze is used for the fixed contact point. A direct plating of Ag is possible, in addition, following the formation of the Ni layer, Ag can be plated for the contact point as well.

Now referring to FIG. 3, it is described a method to reduce a contact resistance between the first contact point 9a and the second contact point 9b.

As shown in FIG. 3, when an electric current flows, while maintaining the first contact point 9a and the second contact 9b as closed, and under applying a vertical or horizontal vibration, a spark is generated so as to break an oxide layer of the surface of the contact point and an activated trace is formed. The reference numeral 10 shows a switch and the reference numeral 11 is a power supply unit. Vibration in the horizontal direction is shown as example in FIG. 3

An electrical current and vibration are applied to the contact points while maintaining the first contact point 9a and the second contact point 9b as closed. A value of the electric current is determined as not to trigger a reversing action of the thermo-sensitive movable element 8 or the movable plate 7a and start separation of the contact points, and the electric current is impressed to external terminals for a prescribed time period. If it is so large as to bring a separation of the contact points, it may not form an effective activated trace. Various values may be chosen considering a user application/design point of view in the thermal protector. A possible range from a design point of view, the impressed current may be 1-50 amp. It is possible not to cause a separation of contact by selecting smaller value of time duration if current value is larger, on the contrary, if even longer time is chosen, the contact may not be brought to separate by selecting relatively smaller current value. A desired activated trace corresponding to the design can be formed by combining and adjusting the following conditions: an impressed current range of 0.1-50 amper, amplitude range of 0.001-0.5 mm, vibration frequency range of 1 kHz-1 GHz, duration of 0.001-1 second. The preferable range of the impressed current is 1-30 amper, and the preferable vibration in a range of 10 kHz-100 KHz frequency, 0.01-0.1 mm amplitude, 0.01-0.1 second time duration. As an example of the vibration, an ultrasonic vibration generator is used, but any type of vibration generator can be adopted.

The process of applying the vibration and electric current can be done simultaneously along with a welding of the resin housing and the top enclosure of the thermal protector by choosing parameters from the range of the invention, or can be done continuously just after welding process of the housing or separately after welding process. Since the vibration conditions (i.e., amplitude, frequency) in the activation treatment is not always identical to the vibration condition in the welding of the housing and the top enclosure, the activation treatment is separately implemented from the welding of the housing and the top enclosure. A manufacturing efficiency may increase when activation and welding processes are employed at the same timing, as described above. Furthermore, it is possible to choose the step of activation following by the welding of the housing or a later timing after welding, considering its manufacturing benefits.

Detail is described below by examples of the embodiments.

### EXAMPLE 1

A comparison testing was conducted on the thermal protector as illustrated configuration in FIG. 1 to evaluate an area of the activated trace of the first contact point and the contact resistance for both of the thermal protector which was activated by a process in accordance with the invention and the thermal protector which was activated by a conventional process. Since a contact resistance depends on the material, Ag—Ni alloy was employed for the contact point in all the cases.

Among several conditions of the activation process shown in Table 1, conditions of No. 1 and No. 2 were chosen as the representatives of the invention and, and for a comparison purpose, No. 10 was chosen. 100 samples of the thermal protectors were made respectively, then the contact resistance and the area of the activated trace of the first contact point were measured. Measurement of the contact resistance was conducted according to JIS C5542 4.5 standard and the area of the activated trace of the first contact point was measured by an image analyzer and the average area was calculated by a computer system attached to this analyzer. The result is shown in Table 2. The areas of the activated trace of the first contact point of the thermal protector which were processed under the conditions No1 and No.2 in accordance with the invention show larger area and smaller resistance than that of the comparison sample of the thermal protector which was processed under the condition No.10.

Each of the ten thermal protectors was randomly sampled from No.1 representing the invention and No10 as comparison sample, then quantity of the activated trace of the first contact point was counted and the area was measured. The result is shown in Table 3 (No.1 representing the invention) and Table 4 (No.10 for comparison sample). As experimentally confirmed as shown in Table 3 and Table 4, the activated trace of the first contact point of the thermal protector processed under the condition according to the invention always have one contour formed, and all the ten thermal protectors have a single trace, while the comparison samples processed under the condition of No.10, nine out of the ten thermal protectors have a single trace formed and one of ten samples has two traces. It is thought that in case of the conventional method where activation was repeated five times (shown in comparison sample), it is rarely formed with a position of spark shifted due to a variation of the surface condition of the contact point or drifting of the initial contact position.

When compared, the area of the activated trace of the first contact point of the sample from No.1, which is made according to the invention, has much larger area than that of the comparison sample No.10. The variation of the activated area is not so large for both cases. One sample from the No.10 has two activated traces formed with approximately twice in size of the total area to others, but its frequency of occurrence is relatively small, the contribution when calculating its average is so small. Therefore, when the average values of the activated traces of 10 thermal protectors are compared, the area of the thermal protector according to the invention is larger than the area of comparison samples and the result in Table 3 shows the same conclusion as Table 2. In addition, in case of thermal protectors made according to the invention, its activated trace of the first contact point is growing to a large size as it slightly moving by vibration but never moved so substantially as one time, the activated trace will always be made being one piece of trace. On the contrary, like a comparison sample No.10, when number of activation was increased, even the chance of occurrence is small, a multiple activated traces of the first contact point of the thermal protector were formed separately, or the activated trace of the first contact point is formed similar to a shape of a bottle grout even though it was not formed as completely separated.

### EXAMPLE 2

100 thermal protectors with the housing 1 and the top enclosure 3 unified by ultrasonic bonding as illustrated configuration in FIG. 2 (Un-activation treatment thermal protector) and another 100 thermal protectors where the activation process is employed as condition No.3 in Table 1 after ultrasonic bonding of the housing 1 and the top enclosure 3 (Activated thermal protector) were prepared, then a drop test and a mechanical stress test were conducted. The drop test was conducted by dropping one face of the thermal protector from 1.8 m height, and the same procedures were repeated twice for each face of six faces of the thermal protector, i.e., 12 trials in total. The mechanical stress test was conducted by placing a prescribed number of thermal protectors into a metal tube container of 1 m length and put a cap on both ends. Then rotating the samples upside and bottom side alternately and rolling the samples 200 times in the container. After that, they were investigated.

After completion of both tests, a contact resistance of a thermal protector was measured in the same manner as described in Example 1. And defect ratio was summarized in Table 5. Defect was defined by a contact resistance exceeding 10 m-Ω. It is obvious from Table 5 that 82 out of 100 samples processed without the activation exceed 10 m-Ω, or its defect ratio is around 80%, while all the samples which applied the activation process according to the invention shows the contact resistance being less than 10 m-Ω, and defect ratio is 0%.

### EXAMPLE 3

100 thermal protectors were made which applied the activation process on the surface of contact point at several conditions as shown in Table 1 after ultrasonic bonding on the housing 1 and the top enclosure 3 using same thermal protectors as described in Example 1. Table 6 shows the result of measurement of the contact resistance and the area of the activated trace on the first contact point and calculated average value in the same manner as descried in Example 1. The contact resistance and the area of the activated trace of the first contact point were evaluated in the same manner as previously described, and defect ratio is shown in Table 6, where the defect is defined by the contact resistance exceeding 10 m-Ω. As a durability test 1, a drop test and mechanical shock test under the same conditions as descried in Example 2 was conducted on the thermal protectors in which the activation process were applied after finished the ultrasonic bonding of the housing 1 and the top enclosure 3. Then the contact resistance was measured and its defect ratio was counted. As a durability test 2, in order to simulate harder condition as user environment for a thermal protector varies, the height of the drop test changed to twice, then a contact resistance was measured and its defect ratio was counted for various activation conditions. All the samples in accordance with the invention passed the durability test 1 which is equivalent to a typical durability test, however, although its quantity was very small, a few defect was recognized depending on the activation process conditions in the durability test 2 which employed harder conditions. Of course, all the samples failed in the durability test 2 had passed the durability test 1, so it is no doubt that all the samples are accepted as the products.

### EXAMPLE 4

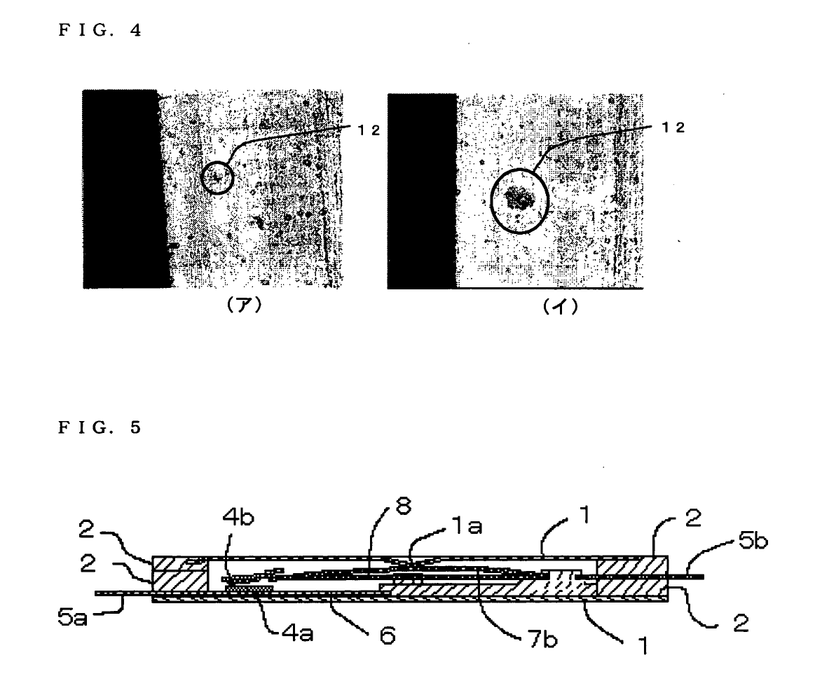

A comparison was made on an activated trace by observing a contact surface through an optical magnifier on thermal protectors, wherein samples were made as Example 2 and either of following activation process was employed: (1) method to form an activated trace by a spark generated when a contact is brought to separate while so large electric current is applied as to start a reverse action of a thermo-sensitive movable element 8 (Conventional method), or (2) method to form a activated trace by applying vibration during electrical current flows through according to the invention (The present invention's method). The result is shown in FIG. 4.

TABLE 1

| | Activation | | Current | Vibration |
|---|---|---|---|---|
| Group | Case No. | Method | (ampere) | condition |
| Present | 1 | Generate a | 5 | Frequency: |
| Invention | | multiple sparks | | 20 KHz, |
| sample | | while electric | | Amplitude: |
| | | current and | | 65 μm |
| | | vibration were | | Duration: |
| | | applied to. | | 100 mSec |
| | 2 | | 5 | Frequency: |
| | | | | 20 KHz, |
| | | | | Amplitude: |
| | | | | 50 μm, |
| | | | | Duration: |
| | | | | 100 mSec |
| | 3 | | 5 | Frequency: |
| | | | | 20 KHz, |
| | | | | Amplitude: |
| | | | | 40 μm |
| | | | | Duration: |
| | | | | 100 mSec |
| | 4 | | 5 | Frequency: |
| | | | | 20 KHz, |
| | | | | Amplitude: |
| | | | | 30 μm |
| | | | | Duration: |
| | | | | 100 mSec |
| | 5 | | 5 | Frequency: |
| | | | | 20 KHz, |
| | | | | Amplitude: |
| | | | | 25 μm |
| | | | | Duration: |
| | | | | 70 mSec |
| | 6 | | 8 | Frequency: |
| | | | | 20 KHz, |
| | | | | Amplitude: |
| | | | | 65 μm |
| | | | | Duration: |
| | | | | 100 mSec |
| Comparison | 10 | Generate a | 15 | — |
| sample | | sparks 5 times | | |
| | | without | | |
| | | vibration | | |
| | | applied. | | |

TABLE 2

| | | | | Average |
|---|---|---|---|---|
| | | | | area of |
| | | | Contact | activated |
| | | Activation | resistance | traces |
| Group | No. | Case No. | (mΩ) | (mm2) |
| Present | 1 | 1 | 5.8 | 0.068 |
| Invention | 2 | 2 | 6.4 | 0.063 |
| sample | | | | |
| Comparison | 10 | 10 | 20 | 0.010 |
| sample | | | | |

TABLE 3

| | N | | | | | | | | | |
|---|---|---|---|---|---|---|---|---|---|---|
| | 1 | 2 | 3 | 4 | 5 | 6 | 7 | 8 | 9 | 10 |
| Quantity of | 1 | 1 | 1 | 1 | 1 | 1 | 1 | 1 | 1 | 1 |
| activated | | | | | | | | | | |
| trace | | | | | | | | | | |
| Area of | 0.068 | 0.07 | 0.061 | 0.067 | 0.07 | 0.061 | 0.08 | 0.063 | 0.071 | 0.062 |
| activated trace | | | | | | | | | | |

TABLE 4

| | N | | | | | | | | | |
|---|---|---|---|---|---|---|---|---|---|---|
| | 1 | 2 | 3 | 4 | 5 | 6 | 7 | 8 | 9 | 10 |
| Quantity of | 1 | 1 | 1 | 1 | 1 | 1 | 1 | 1 | 1 | 1 |
| activated | | | | | | | | | | |
| trace | | | | | | | | | | |
| Area of | 0.01 | 0.009 | 0.011 | 0.012 | 0.01 | 0.011 | 0.01 | 0.021 | 0.011 | 0.012 |
| activated trace | | | | | | | | | | |

TABLE 5

| | | Activation | | Defect ratio |
|---|---|---|---|---|
| Group | No. | Case No. | Sample Condition | (%) |
| Present | 3 | 1 | Ultrasonic | 0 |
| Invention | | | bonding->activating | |
| sample | | | process added | |
| Comparison | 11 | — | Ultrasonic bonding | 80 |
| sample | | | only (no activating | |
| | | | process) | |

TABLE 6

| | | | | Average | | |
|---|---|---|---|---|---|---|
| | | Acti- | Average | area of | | |
| | | vation | contact | activated | Dura- | Dura- |
| | | Case | resistance | trace | tion | tion |
| Group | No. | No. | (mΩ) | (mm2) | Test-1 | Test-2 |
| Present | 4 | 6 | 5.4 | 0.082 | 0 | 0 |
| Invention | 5 | 2 | 6.0 | 0.063 | 0 | 0 |
| sample | 6 | 3 | 6.2 | 0.043 | 0 | 0 |
| | 7 | 4 | 6.5 | 0.032 | 0 | 1 |
| | 8 | 5 | 6.8 | 0.021 | 0 | 5 |
| Comparison | 12 | 10 | 20 | 0.01 | 10 | 30 |
| sample | | | | | | |

The type of activated trace of first contact point is a collectives which is formed by a continuous contour and a set of partially overlapped trace as shown in FIG. 4-B according to an embodiment of the invention. However, almost all activated trace formed by a conventional process is a concentrated type in one point as shown in FIG. 4-A. When activation is treated at multiple times in the comparison sample, almost all activated trace of first contact point are formed in one concentrated area, but like sample N8 in Table 4, it occurred sometimes the activated trace of first contact point was formed in differed location. In this case, the activated trace of first contact points is formed in two or three separated positions or its center shifted in large distance. The mechanism to generate the type of activated traces on a first contact point can be assumed that a contact point shifted by melting of contact material by a spark when energized, or by releasing a residual stress after a movable plate is heated by electrical power and left as made.

As above it is demonstrated from the result in Table 1 through Table 4 and Table 6 that; a thermal protector and a method of reducing a contact resistance according to the invention can make a larger activated trace on first contact point than it by conventional method and also form an newly exposed area having a continuous contour. From the result, it realized smaller contact resistance than 7.0 μΩ and maintained its appropriate contact resistance value even under receiving an accidental drop or shock impact or others during in use .

Furthermore, from the result in Table 5, Sample No. 3 which adopted a method of reducing a contact resistance in accordance with the invention showed a significant effect in degrading mechanism of contact resistance under drop and shock impact during actual use, and it was possible to reduce a defect of a thermal protector significantly compared to comparison sample No.11 which was not applied the method of reducing contact resistance.

FIG. 4-A shows an activated trace on first contact point according to the conventional method, and FIG. 4-B shows an activated trace on first contact point according to the invention.

It is obvious from FIG. 4 that, compared to a conventional method, an activated trace on first contact point processed according to the invention shows a larger and continuous petal shape (for example, it is surrounded by a continuous curved line and its circumference has a minute concave and convex line). Like this, it is shown the difference in terms of a shape of activated trace deeply relates to a method also significant difference in the effect can be seen.

According to the invention, it is possible to maintain low contact resistance although while a pressure of electrical contact is low. In addition, it is possible to maintain low contact resistance of a contact point of a thermal protector and other electrical apparatus by removing a concentration of an oxidation material around a contact surface which cause a contact resistance increased. The invention provides a method of maintaining low contact resistance of an electrical apparatus and provides an electric devices using that outcome, and it provides electronics components and a mobile terminal/mobile apparatus such as a cellular phone, a notebook personal computer and the like which use an electrical contact realized by the invention.

1. A thermal protector which functions to close or open contact between a first contact point and a second contact point being aligned opposed to the first contact point provided on a movable plate, wherein said thermal protector has an activated trace formed by applying vibration during an activation process on at least one surface of said first contact point and said second contact point.

2. A thermal protector comprising:
a first contact point electrically connected to a first external terminal through a fixed plate; and,
a second contact point being aligned opposed to said first contact point and electrically connected to a second external terminal through a movable plate,
wherein said thermal protector has an activated trace formed by applying vibration and electrical current flow during an activation process on at least one surface of said first contact point and said second contact point.

3. A thermal protector comprising:
a first contact point electrically connected to a first external terminal through a fixed plate;
a second contact point which being aligned opposed to said first contact point and electrically connected to a second external terminal through a movable plate; and,
a device to force to separate a contact between said first contact point and said second contact point,
wherein said thermal protector has an activated trace formed by applying vibration and electrical current flow during an activation process on at least one surface of said first contact point and said second contact point.

4. A thermal protector comprising:
a first contact point electrically connected to a first external terminal through a fixed plate; and,
a second contact point electrically connected to a second external terminal through a movable plate,
wherein an activated trace is formed on a surface of said first contact point, and said activated trace comprises a collectives of activated trace gathering from a piece of trace which is partially overlapped.

5. A thermal protector comprising:
a first contact point electrically connected to a first external terminal through a fixed plate;
a second contact point electrically connected to a second external terminal through a movable plate; and,
a device to force to separate a contact between said first contact point and said second contact point,
wherein an activated trace is formed on a surface of said first contact point, and said activated trace comprises a collectives of activated trace gathering from a piece of trace which is partially overlapped.

6. A thermal protector as claimed in any one of claims 1 to 5, wherein an activated trace formed on said first contact point processed with applying vibration has a larger area than that processed without vibration when same electric current value is used to form activated trace.

7. A thermal protector as claimed in any one of claims 1 to 5, wherein an activated trace formed on said first contact point processed with applying vibration has a larger area by at least two times than an average area formed on said first contact point processed without vibration.

8. A thermal protector as claimed in any one of claims 1 to 5, wherein an activated trace formed on said first contact point processed with applying vibration has a larger area by at least four times than an average area formed on said first contact point processed without vibration.

9. A thermal protector as claimed in claim 1, 2 or 4, wherein a movable plate is formed by a thermo-sensitive movable element.

10. A thermal protector as claimed in claim 1, 3 or 5, wherein a thermo-sensitive movable element functions to separate contact of said first contact point and said second contact point being aligned opposed in pair.

11. A thermal protector as claimed in any one of claims 1 to 5, wherein said first contact point and second contact point are made of one metal selected from a group consisting of Ag, Ni, Cu, Be, Ti, Fe. Cr and C, or an alloy thereof.

12. A method for reducing contact resistance of electrical contact point in an electrical apparatus including a first external terminal and second external terminal which are electrically isolated, a first contact point electrically connected to said first external terminal, and a second contact point electrically connected to said second external terminal being aligned opposed to the first contact point in pair, comprising the steps of:
maintaining surfaces of said first contact point and said second contact point to be closed state; and,
forming an activated trace with applying vibration and electrical current flow to form a activated trace.

13. A method for reducing contact resistance of electrical contact point in an electrical apparatus including a first external terminal and second external terminal which are electrically isolated, a first contact point electrically connected to said first external terminal, a second contact point electrically connected to said second external terminal being aligned opposed to the first contact point in pair, and a device to force to separate a contact between said first contact point and said second contact point, comprising the steps of:
maintaining surfaces of said first contact point and said second contact point to be closed state; and,
forming an activated trace with applying vibration and electrical current flow to form a activated trace.

14. A method for reducing contact resistance of electrical contact point, wherein said electrical contact point as claimed in claim12 or claim13 comprises a contact points in a thermal protector.

15. A method for reducing contact resistance of a thermal protector as claimed in claim 14, wherein vibration in a range of 1 kHz-1 GHz frequency and 0.001-0.5 mm amplitude is applied for duration of 0.001-1 second, while applying an electric current flow of 0.1-50 ampere to said first and second contact point while in closed state.

16. A method for reducing contact resistance of a thermal protector as claimed in claim 14, wherein vibration in a range of 10 kHz-100 KHz frequency and 0.01-0.1 mm amplitude is applied for duration of 0.01-0.1 second, while applying an electric current flow of 1-30 ampere.

17. A method for reducing contact resistance of a thermal protector as claimed in claim 14, wherein vibration to activate is applied in simultaneous when welding a housing of a thermal protector to utilize vibration induced from welding, continuous from welding process of a housing, or later following after welding process of a housing.

18. An electrical component having a thermal protector as claimed in any one of claims 1 to 5.

19. A cellular phone having a thermal protector as claimed in any one of claims 1 to 5.

20. A notebook personal computer having a thermal protector as claimed in any one of claims 1 to 5.

21. A mobile type electrical apparatus having a thermal protector as claimed in any one of claims 1 to 5.
